(19) United States
(12) Patent Application Publication
(10) Pub. No.: US 2017/0005882 A1
(43) Pub. Date: Jan. 5, 2017

(54) Service Chain Management Method, System and Device

(71) Applicant: ZTE CORPORATION, Shenzhen, Guangdong (CN)

(72) Inventors: Quanjun TAO, Shenzhen City, Guangdong Province (CN); Se WU, Shenzhen City, Guangdong Province (CN); Jianfeng ZHOU, Shenzhen City, Guangdong Province (CN); Tian TIAN, Shenzhen City, Guangdong Province (CN)

(21) Appl. No.: 15/113,525

(22) PCT Filed: Aug. 14, 2014
(86) PCT No.: PCT/CN2014/084382

§ 371 Date: Jul. 22, 2016

(30) Foreign Application Priority Data
Jan. 24, 2014 (CN) 201410036434.7

(51) Int. Cl. H04L 12/24; H04L 12/911

(52) U.S. Cl. CPC H04L 41/50; H04L 47/78; H04L 47/82

(57) ABSTRACT

A service chain management method, system and device are disclosed. The system comprises a service arrangement device for generating a service chain mapping table and sending the service chain mapping table to a policy control device, wherein the service chain mapping table comprises service chain identifications and corresponding service chain condition features; the policy control device for searching for a corresponding service chain identification in the service chain mapping table according to the service chain condition features of user equipment and generating a policy rule table and/or a service detection rule table of the user equipment, wherein the policy rule table and/or the service detection rule table comprises service chain identification operation information; and a policy execution device for receiving a message and executing a policy rule and/or a service detection rule for the received message according to the policy rule table and/or the service detection rule table.

### CROSS-REFERENCE TO RELATED APPLICATION(S)

This application is the U.S. National Phase application of PCT application number PCT/CN2014/084382 having a PCT filing date of Aug. 14, 2014, which claims priority of Chinese patent application 201410036434.7 filed on Jan. 24, 2014, the disclosures of which are hereby incorporated by reference.

### TECHNICAL FIELD

The present invention relates to a mobile value-added service network technology, in particular to a service chain management method, system and device.

### BACKGROUND OF RELATED ART

At present, in order to improve quality of experience of users and reduce network bandwidth pressure, operators provide value-added service by deploying mobile value-added service networks. Service Chains (SCs) of mobile value-added service networks in the related art mainly have two modes. FIG. 1(a) is a service chain mode 1 of a mobile value-added service network in the related art; and FIG. 1(b) is a service chain mode 2 of a mobile value-added service network in the related art.

As shown in FIG. 1(a), in mode 1, service nodes are statically linked together through a switch, and a packet gateway uses Access Point Names (APNs) to distinguish different service chains. After the packet gateway receives a message, the packet gateway transmits the message to the corresponding service chain according to the APN in the message. In mode 1, the service chain corresponding to the APN is relatively static, the service nodes can only be deployed according to a given order, a network topology change will be caused when a service node is added into or removed from the service chain or the logic of the service chain is simply changed, artificial reconfiguration is needed and it is difficult to adapt to elastic quick service deployment change.

As shown in FIG. 1(b), in mode 2, all service nodes are connected to a routing controller, a packet gateway transmits a message to the routing controller, the routing controller decides a next-hop service node, the service node performs related processing after receiving the message, the processed message is transmitted to the routing controller, and the routing controller then decides a next-hop service node till accessing to the Internet or a mobile value-added service network. In mode 2, a CAPital eXpendicture (CAPX) of the routing controller is high and the function thereof is overlapped with the function of the packet gateway.

### SUMMARY OF THE INVENTION

In order to solve the above-mentioned problem, the embodiments of the present invention provide a service chain management method, system and device and can simply realize dynamic configuration of service chains, such that the dynamically configured service chains can adapt to elastic quick service deployment change.

In order to achieve the above-mentioned purpose, the embodiment of the present invention provides a service chain management system, comprising a service arrangement device, a policy control device and a policy execution device, wherein:

the service arrangement device is configured to generate a service chain mapping table and send the service chain mapping table to the policy control device, the service chain mapping table comprises service chain identifications and corresponding service chain condition features;

the policy control device is configured to search for a corresponding service chain identification in the service chain mapping table according to a service chain condition feature of user equipment and generate a policy rule table and/or a service detection rule table of the user equipment, the policy rule table and/or the service detection rule table comprises service chain identification operation information; and

the policy execution device is configured to receive a message and execute a policy rule and/or a service detection rule for the received message according to the policy rule table and/or the service detection rule table.

More preferably, the service arrangement device is further configured to arrange a service logic link table, the service logic link table comprises service chain identifications and corresponding service node arrangement sequences;

the system further comprises a network management device and a switching device;

the policy execution device is further configured to forward the message obtained after the execution of the policy rule and/or service detection rule to the switching device;

the network management device is configured to generate a service chain routing table according to a network topology and the service logic link table; and

the switching device is configured to forward the message obtained after the execution of the policy rule and/or the service detection rule according to the service chain routing table.

More preferably, the policy rule table and/or the service detection rule further comprises a service judgment template.

More preferably, the service judgment template comprises service types and field information for judging the service types.

More preferably, the service chain identification operation information is used for instructing the policy execution module to add a service chain identification at a specific position in the message obtained after the execution of the policy rule and/or the service detection rule, the specific position is statically configured by the policy control module or is indicated by the service arrangement module in the service chain mapping table.

More preferably, the service chain condition features comprise service types, user levels, access types and wireless network states; and the policy control device is configured to:

when the user equipment accesses to a network, search for a corresponding service type in the service chain condition features of the service chain mapping table according to a user level, an access type and a wireless network state of the user equipment, search for corresponding field information for judging the service type in the service identification template according to the searched service type, and if judging that the searched field information for judging the service type is one or a combination of a plurality of fields at layers 2-4, save a user identification in the policy rule table of the user, and save the searched service type and the field information for judging the service type in the service judgment template of the policy rule table of the user; and

if judging that the searched field information for judging the service type is fields at layers 4-7, save the user identification in the service detection rule table of the user, and save the searched service type and the field information for judging the service type in the service judgment template of the service detection rule table of the user,

wherein the service identification template is generated by the service arrangement device or is statically configured by the policy control device; and the service identification template comprises the service types and the field information for judging the service types.

More preferably, the policy execution device is configured to:

save the policy rule table and the service detection rule table; receive a message, search for a service type of the received message in the service judgment template in the policy rule table according to field information for judging the service type in the message, insert a service chain identification in the received message according to an operation corresponding to the searched service type, and forward the message obtained after the insertion of the service chain identification to the switching device.

More preferably, the policy execution device is further configured to:

when the service type of the received message is not searched in the service judgment template in the policy rule table, search for the service type of the received message in the service judgment template in the service detection rule table, insert the service chain identification in the received message according to an operation corresponding to the searched service type, and forward the message to the switching device.

More preferably, the policy execution device is further configured to:

when the service type of the received data message is not searched in the service judgment template of the service detection rule table, exit service chain processing.

More preferably, the service nodes consist of addresses of hosts or virtual machines, or addresses and instance identifications of the hosts or the virtual machines.

More preferably, the network management device is configured to:

acquire address information of a service chain table node in the service logic link table; acquire a switching device related to the service chain table node according to information of the network topology; and generate a service chain routing table corresponding to the switching device according to the service logic link table and send the service chain routing table to the switching device.

More preferably, the service chain routing table comprises input ports, service chain identifications and corresponding output ports.

The embodiment of the present invention further provides a service arrangement device, comprising:

a generation module configured to generate a service chain mapping table and send the service chain mapping table to a policy control device, wherein the service chain mapping table comprises service chain identifications and corresponding service chain condition features.

More preferably, the generation module is further configured to arrange a service logic link table, wherein the service logic link table comprising service chain identifications and corresponding service node arrangement sequences.

The embodiment of the present invention further provides a policy control device, comprising:

a search module configured to search for a corresponding service chain identification in a service chain mapping table according to a service chain condition feature of user equipment and generate a policy rule table and/or a service detection rule table of the user equipment, wherein the policy rule table and/or the service detection rule table comprises service chain identification operation information.

More preferably, the service chain condition features comprise service types, user levels, access types and wireless network states; and the search module is configured to:

when the user equipment accesses to a network, search for a corresponding service type in the service chain condition features of the service chain mapping table according to a user level, an access type and a wireless network state of the user equipment, and search for corresponding field information for judging the service type in a service identification template according to the searched service type;

if judging that the searched field information for judging the service type is one or a combination of a plurality of fields at layers 2-4, save a user identification in the policy rule table of the user, and save the searched service type and the field information for judging the service type in the service judgment template of the policy rule table of the user; and if judging that the searched field information for judging the service type is fields at layers 4-7, save the user identification in the service detection rule table of the user, and save the searched service type and the field information for judging the service type in the service judgment template of the service detection rule table of the user.

The embodiment of the present invention further provides a policy execution device, comprising:

a policy execution module configured to save a policy rule table; receive a message and search for a service type of the received message in a service judgment template of the policy rule table according to field information for judging the service type in the message; and insert a service chain identification in the received message according to an operation corresponding to the searched service type, and forward the message obtained after the insertion of the service chain identification to a switching device; and

a service detection module configured to save a service detection rule table.

More preferably, the policy execution module is further configured to, when the service type of the received message is not searched in the service judgment template in the policy rule table, forward the received message to the service detection module; and

the service detection module is further configured to receive the message from the policy execution module; search for the service type of the received message in the service judgment template of the service detection rule table; and insert a service chain identification in the received message according to an operation corresponding to the searched service type, and forward the message obtained after the insertion of the service chain identification to the switching device.

The embodiment of the present invention further provides a network management device, comprising:

an acquisition module configured to acquire address information of a service chain table node in a service logic link table; and acquire a switching device related to the service chain table node according to information of a network topology; and

a generation module configured to generate a service chain routing table corresponding to the switching device according to the service logic link table and send the service chain routing table to the switching device.

More preferably, the service chain routing table comprises input ports, service chain identifications and corresponding output ports.

The embodiment of the present invention further provides a service chain management method, comprising:

generating a service chain mapping table;

searching for a corresponding service chain identification in the service chain mapping table according to a service chain condition feature of user equipment and generating a policy rule table and/or a service detection rule table of the user equipment, wherein the policy rule table and/or the service detection rule table comprises service chain identification operation information; and

receiving a message and executing a policy rule and/or a service detection rule for the received message according to the policy rule table and/or the service detection rule table.

More preferably, the method further comprises:

arranging a service logic link table, wherein the service logic link table comprises service chain identifications and corresponding service node arrangement sequences;

generating a service chain routing table according to a network topology and the service logic link table; and

forwarding the message obtained after the execution of the policy rule and/or the service detection rule according to the service chain routing table.

More preferably, the policy rule table and/or the service detection rule further comprises a service judgment template.

More preferably, the service judgment template comprises service types and field information for judging the service types.

More preferably, the service chain identification operation information is used for instructing to add a service chain identification at a specific position in the message obtained after the execution of the policy rule and/or the service detection rule, the specific position is statically configured or is indicated in the service chain mapping table.

More preferably, searching for a corresponding service chain identification in the service chain mapping table according to a service chain condition feature of user equipment and generating a policy rule table and/or a service detection rule table of the user equipment comprises:

when the user equipment accesses to a network, searching for a corresponding service type in the service chain condition features of the service chain mapping table according to a user level, an access type and a wireless network state of the user equipment, searching for corresponding field information for judging the service type in the service identification template according to the searched service type, and if judging that the searched field information for judging the service type is one or a combination of a plurality of fields at layers2-4, saving a user identification in the policy rule table of the user, and saving the searched service type and the field information for judging the service type in the service judgment template of the policy rule table of the user; and

if judging that the searched field information for judging the service type is fields at layers 4-7, saving the user identification in the service detection rule table of the user, and saving the searched service type and the field information for judging the service type in the service judgment template of the service detection rule table of the user,

wherein the service identification template is generated in advance or is statically configured; and the service identification template comprises the service types and the field information for judging the service types.

More preferably, receiving a message and executing a policy rule and/or a service detection rule for the received message according to the policy rule table and/or the service detection rule table comprises:

receiving a message, searching for a service type of the received message in the service judgment template in the policy rule table according to field information for judging the service type in the message, inserting a service chain identification in the received message according to an operation corresponding to the searched service type, and forwarding the message obtained after the insertion of the service chain identification to a switching device.

More preferably, when the service type of the received message is not searched in the service judgment template in the policy rule table, the method further comprises:

searching for the service type of the received message in the service judgment template in the service detection rule table, inserting the service chain identification in the received message according to an operation corresponding to the searched service type, and forwarding the message to the switching module.

More preferably, when the service type of the received data message is not searched in the service judgment template of the service detection rule table, the method further comprises:

exiting service chain processing.

More preferably, the service logic link table comprises service chain identifications and service node arrangement sequences corresponding to the service chain identifications; and

the service nodes consist of addresses of hosts or virtual machines, or addresses and instance identifications of the hosts or the virtual machines.

More preferably, generating a service chain routing table according to a network topology and the service logic link table comprises:

acquiring address information of a service chain table node in the service logic link table; acquiring a switching device related to the service chain table node according to information of the network topology; and generating a service chain routing table corresponding to the switching device according to the service logic link table and sending the service chain routing table to the switching device.

More preferably, the service chain routing table comprises input ports, service chain identifications and corresponding output ports.

Through the solutions provided by the embodiments of the present invention, dynamic configuration of service chains is realized, such that the dynamically-configured service chains are applicable to elastic quick service deployment change.

### BRIEF DESCRIPTION OF THE DRAWINGS

The drawings in the embodiments of the present invention will be described below. The drawings in the embodiments are used for further understanding the present invention, and are used together with the description for explaining the present invention and do not constitute limitations on the protection scope of the present invention.

FIG. 1(a) is a service chain mode 1 of a mobile value-added service network in the related art;

FIG. 2(b) is a service chain mode 2 of a mobile value-added service network in the related art;

FIG. 2 is a schematic diagram of structural composition of a service chain management system provided by the embodiment of the present invention;

FIG. 3 is a schematic diagram of structural composition of a policy execution device provided by the embodiment of the present invention;

FIG. 4 is a schematic diagram of structural composition of a network management device provided by the embodiment of the present invention;

FIG. 5 is a flowchart of a service chain management method provided by the embodiment of the present invention.

### PREFERRED EMBODIMENTS OF THE INVENTION

The embodiments of the present invention will be described below in detail in combination with the drawings. It needs to be stated that the embodiments in the present application and the features in the embodiments can be freely combined in the case no conflict.

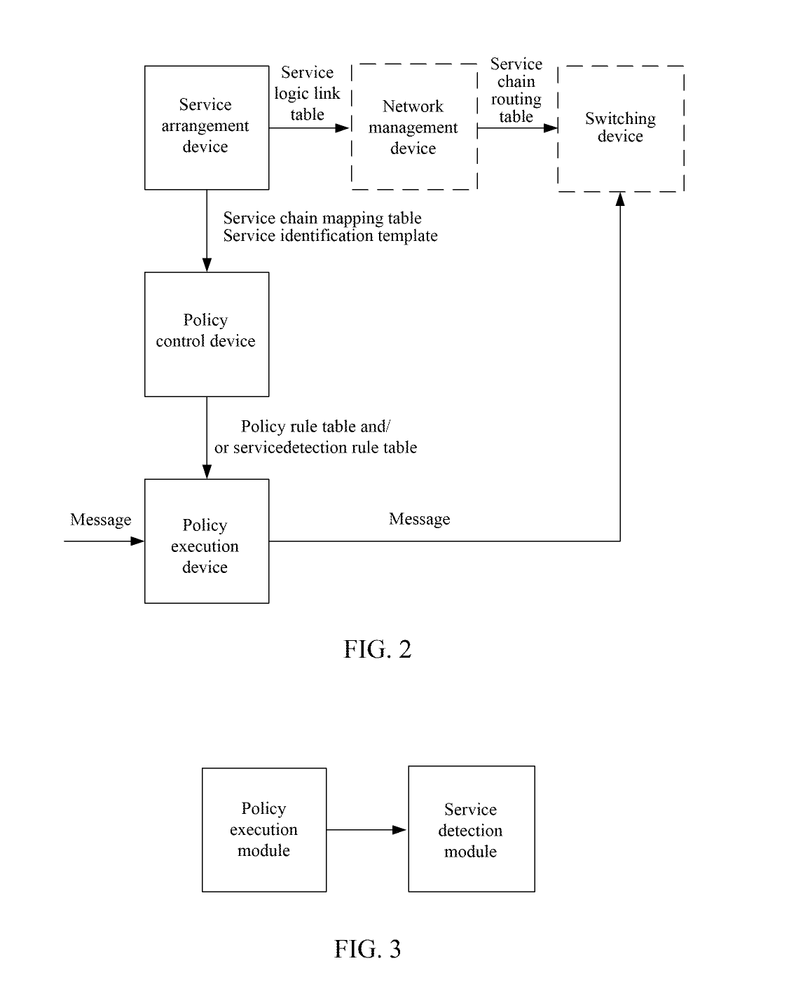

Referring to FIG. 2, the embodiment of the present invention provides a service chain management system, comprising:

a service arrangement device configured to generate a service chain mapping table and send the service chain mapping table to a policy control device, wherein the service chain mapping table comprises service chain identifications and corresponding service chain condition features;

the policy control device configured to search for a corresponding service chain identification in the service chain mapping table according to a service chain condition feature of user equipment and generate a policy rule table and/or a service detection rule table of the user equipment, wherein the policy rule table and/or the service detection rule table comprises service chain identification operation information; and

a policy execution device configured to receive a message and execute a policy rule and/or a service detection rule for the received message according to the policy rule table and/or the service detection rule table.

In the system provided by the embodiment of the present invention, the service arrangement device is further configured to arrange a service logic link table, the service logic link table comprises service chain identifications and corresponding service node arrangement sequences; and

the system further comprises:

a network management device configured to generate a service chain routing table according to a network topology and the service logic link table; and

a switching device configured to forward the message obtained after the execution of the policy rule and/or the service detection rule according to the service chain routing table.

In the system provided by the embodiment of the present invention, the policy rule table and/or the service detection rule further comprises a service judgment template.

Therein, the service judgment template comprises service types and field information for judging the service types.

In the system provided by the embodiment of the present invention, the service chain identification operation information is used for instructing the policy execution module to add a service chain identification at a specific position in the message obtained after execution of the policy rule and/or the service detection rule, the specific position is statically configured by the policy control module or is indicated by the service arrangement module in the service chain mapping table.

In the system provided by the embodiment of the present invention, the service chain condition features comprise service types, user levels, access types and wireless network states; and the policy control device is configured to:

when the user equipment accesses to a network, search for a corresponding service type in the service chain condition features of the service chain mapping table according to a user level, an access type and a wireless network state of the user equipment, search for corresponding field information for judging the service type in the service identification template according to the searched service type, and if judging that the searched field information for judging the service type is one or a combination of a plurality of fields at layers 2-4, save a user identification in the policy rule table of the user, and save the searched service type and the field information for judging the service type in the service judgment template of the policy rule table of the user; and

if judging that the searched field information for judging the service type is fields at layers 4-7, save the user identification in the service detection rule table of the user, and save the searched service type and the field information for judging the service type in the service judgment template of the service detection rule table of the user,

wherein the service identification template is generated by the service arrangement device or is statically configured by the policy control device; and the service identification template comprises the service types and the field information for judging the service types.

In the system provided by the embodiment of the present invention, the policy execution device is configured to:

save the policy rule table and the service detection rule table; receive a message, search for a service type of the received message in the service judgment template in the policy rule table according to field information for judging the service type in the message, insert a service chain identification in the received message according to an operation corresponding to the searched service type, and forward the message obtained after the insertion of the service chain identification to the switching device.

In the system provided by the embodiment of the present invention, the policy execution device is further configured to:

when the service type of the received message is not searched in the service judgment template in the policy rule table, search for the service type of the received message in the service judgment template in the service detection rule table, insert the service chain identification in the received message according to an operation corresponding to the searched service type, and forward the message to the switching module.

In the system provided by the embodiment of the present invention, the policy execution device is further configured to:

when the service type of the received data message is not searched in the service judgment template of the service detection rule table, exit service chain processing.

In the system provided by the embodiment of the present invention, the service nodes consist of addresses of hosts or virtual machines, or addresses and instance identifications of the hosts or the virtual machines.

In the system provided by the embodiment of the present invention, the network management device is configured to:

acquire address information of the service chain table node in the service logic link table; acquire a switching device related to the service chain table node according to information of the network topology; and generate a service chain routing table corresponding to the switching device according to the service logic link table and send the service chain routing table to the switching device.

In the system provided by the embodiment of the present invention, the service chain routing table comprises input ports, service chain identifications and corresponding output ports.

The embodiment of the present invention further provides a service arrangement device, at least comprising:

a generation module configured to generate a service chain mapping table and send the service chain mapping table to a policy control device, wherein the service chain mapping table comprises service chain identifications and corresponding service chain condition features.

In the service arrangement device provided by the embodiment of the present invention, the generation module is further configured to arrange a service logic link table, wherein the service logic link table comprises service chain identifications and corresponding service node arrangement sequences.

The embodiment of the present invention further provides a policy control device, at least comprising:

a search module configured to search for a corresponding service chain identification in a service chain mapping table according to a service chain condition feature of user equipment and generate a policy rule table and/or a service detection rule table of the user equipment, wherein the policy rule table and/or the service detection rule table comprises service chain identification operation information.

In the policy control device provided by the embodiment of the present invention, the service chain condition features comprise service types, user levels, access types and wireless network states; and the search module is configured to:

when the user equipment accesses to a network, search for a corresponding service type in the service chain condition features of the service chain mapping table according to a user level, an access type and a wireless network state of the user equipment, and search for corresponding field information for judging the service type in a service identification template according to the searched service type;

if judging that the searched field information for judging the service type is one or a combination of a plurality of fields at layers 2-4, save a user identification in the policy rule table of the user, and save the searched service type and the field information for judging the service type in the service judgment template of the policy rule table of the user; and if judging that the searched field information for judging the service type is fields at layers 4-7, save the user identification in the service detection rule table of the user, and save the searched service type and the field information for judging the service type in the service judgment template of the service detection rule table of the user.

Referring to FIG. 3, the embodiment of the present invention further provides a policy execution device, at least comprising:

a policy execution module configured to save a policy rule table; receive a message and search for a service type of the received message in a service judgment template of the policy rule table according to field information for judging the service type in the message; and insert a service chain identification in the received message according to an operation corresponding to the searched service type, and forward the message obtained after the insertion of the service chain identification to a switching device; and

a service detection module configured to save a service detection rule table.

In the policy execution device provided by the embodiment of the present invention, the policy execution module is further configured to, when the service type of the received message is not searched in the service judgment template in the policy rule table, forward the received message to the service detection module; and

the service detection module is further configured to receive the message from the policy execution module; search for the service type of the received message in the service judgment template of the service detection rule table; and insert the service chain identification in the received message according to an operation corresponding to the searched service type, and forward the message obtained after the insertion of the service chain identification to the switching device.

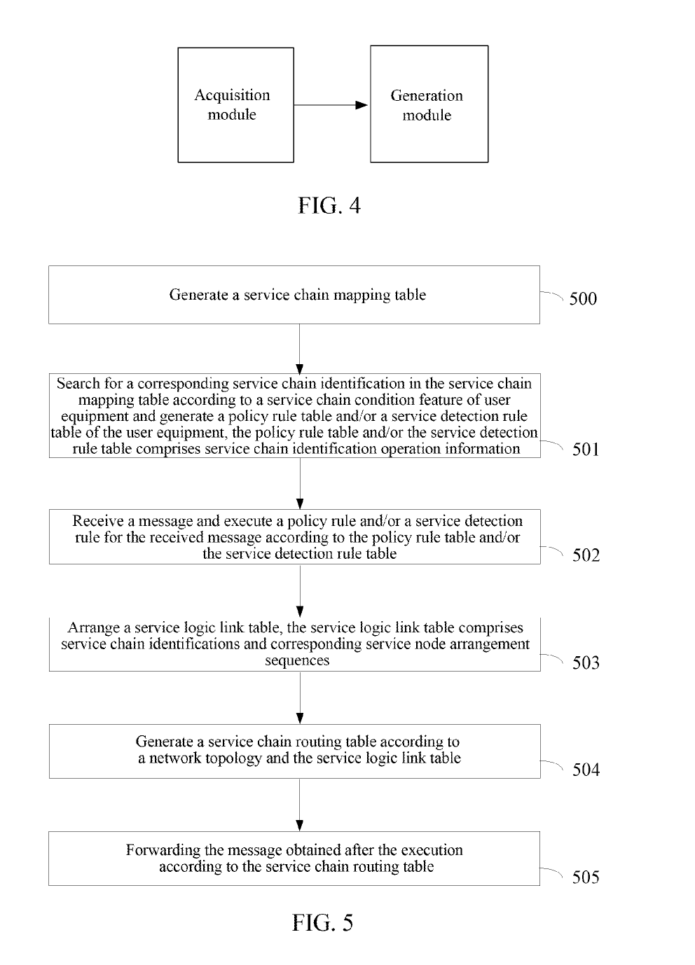

Referring to FIG. 4, the embodiment of the present invention further provides a network management device, comprising:

an acquisition module configured to acquire address information of a service chain table node in a service logic link table; and acquire a switching device related to the service chain table node according to information of a network topology; and

a generation module configured to generate a service chain routing table corresponding to the switching device according to the service logic link table and send the service chain routing table to the switching device.

In the network management device provided by the embodiment of the present invention, the service chain routing table comprises input ports, service chain identifications and corresponding output ports.

Referring to FIG. 5, the embodiment of the present invention further provides a service chain management method, comprising:

At Step 500, it is to generate a service chain mapping table.

In this step, how to generate the service chain mapping table belongs to the prior art and cannot be used for limiting the protection range of the present invention.

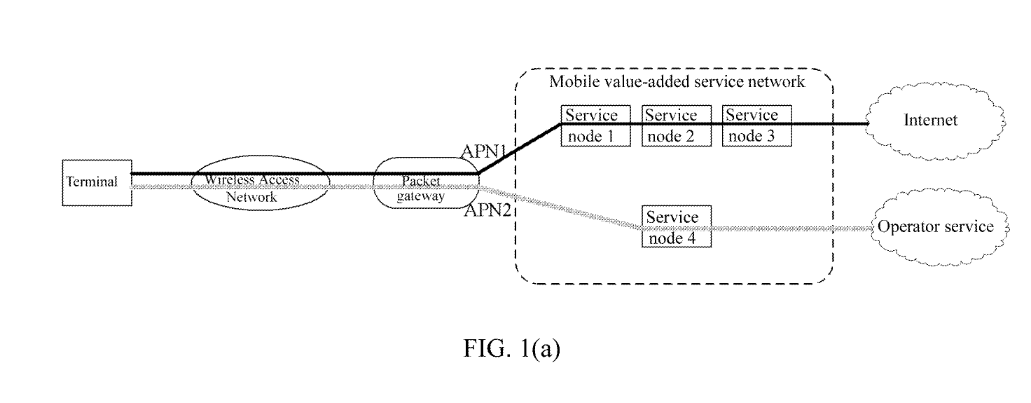

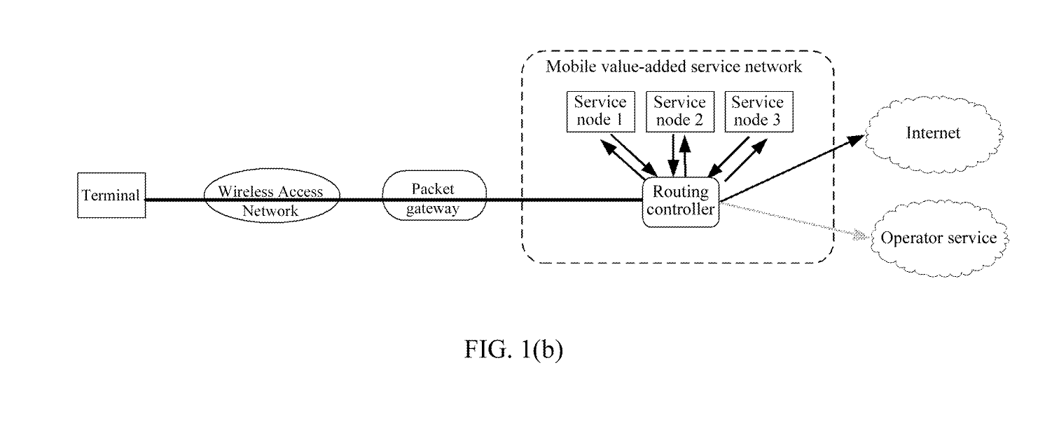

In this step, as shown in FIG. 1, the service chain mapping table comprises service chain identifications and corresponding service chain condition features, and the service chain condition features comprise service types, user levels, access types, wireless network states and data stream directions corresponding to the service chain identifications.

TABLE 1

| | Service chain condition feature | | | | |
|---|---|---|---|---|---|
| Service chain | | User | Access | Wireless | Data stream |
| identification | Service type | level | type | network state | direction |
| Service chain 1 | WAP (Wireless | High | 3G | Congestion | Up (from user to |
| | Application | | | | value-added |
| | Protocol) | | | | network) |
| Service chain 2 | WAP | Lower | 2G | Non- | Down (from |
| | | | | congestion | value-added |
| | | | | | network to user) |
| Service chain 3 | P2P (Peer to Peer) | All | All | Non- | Down |
| | | | | congestion | |
| Service chain 4 | Internet | High | 2G | Congestion | Up |
| . . . | | | | | |

Therein, the service chain identifications can consist of, but not limited to, Virtual Local Area Network (VLAN) identifications and Multi-Protocol Label Switching (MPLS) identifications. The specific composition of the service chain identifications is not limited in the present invention, as long as each service chain in a network can be distinguished. Specific composition thereof should not be used for limiting the protection range of the present invention.

The service type can be Wireless Application Protocol (WAP), Peer to Peer (P2P), Internet or the like.

The user level can be High, Lower or All (no priority).

The access type can be 2G, 3G or All (others).

The wireless network state can be congestion or non-congestion.

The data stream direction can be Up (from user to value-added network) or Down (from value-added network to user).

At Step 501, it is to search for a corresponding service chain identification in the service chain mapping table according to a service chain condition feature of user equipment and generate a policy rule table and/or a service detection rule table of the user equipment, the policy rule table and/or the service detection rule table comprises service chain identification operation information.

In this step, the service chain identification operation information can be the insertion of a service chain identification at a specific position of a message, and the specific position of the message can be statically configured and can also be indicated by an indication carried in the service chain mapping table.

Therein, the service chain identification corresponds to the service type. For example, if the service type is Internet, the service chain identification inserted at the specific position of the message is a service chain identification corresponding to Internet.

In this step, as shown in FIG. 2, the policy rule table or the service detection rule table further comprises a service identification template.

TABLE 2

| User | | Service chain |
|---|---|---|
| identification | Service judgment template | identification |
| (IMSI) | (TFT) | operation information |
| 46002000000001 | 5-tuple (source/destination | Insertion of service chain |
| | address) | identification |

In Table 2, the user identification can be an International Mobile Subscriber Identification Number (IMSI).

As shown in Table 3, the service identification/judgment template comprises service types and field information for judging the service types.

TABLE 3

| | Field at | Field at | Field at | Fields at layers 4-7 | | |
|---|---|---|---|---|---|---|
| | layer 2 | layer 3 | layer 4 | Field | | |
| Service | MAC, VLAN, | IP | TCP/UDP | pointer | Field | Field |
| type | MPLS, etc. | address | port | offset | length | value |
| WAP | XX | XX | XX | Xx | Xx | Xx |
| Internet | | | | | | |
| P2P | | | | | | |
| . . . | | | | | | |

In Table 3, the service type can be WAP, P2P, Internet or the like.

The field information for judging the service type can be one or a combination of a plurality of the following fields: field at layer 2, field at layer 3, field at layer 4 and fields at layers 4-7, wherein p the field at layer 2 can be a Media Access Control (MAC) address, a Multi-Protocol Label Switching (MPLS) identification or a Virtual Local Area Network (VLAN) identification; the field at layer 3 can be an Internet Protocol (IP) address; the field at layer 4 can be a Transmission Control Protocol (TCP)/User Datagram Protocol (UDP) port; and the fields at layers 4-7 can consist of a field pointer offset, a field length and a field value.

In this step, when the user equipment accesses to a network, a corresponding service type is searched in the service chain condition features of the service chain mapping table according to a user level, an access type and a wireless network state of the user equipment, corresponding field information for judging the service type is searched in a service identification template according to the searched service type, and if judging that the searched field information for judging the service type is one or a combination of a plurality of fields at layers 2-4, a user identification is saved in the policy rule table of the user, and the searched service type and the field information for judging the service type are saved in the service judgment template of the policy rule table of the user; and

if judging that the searched field information for judging the service type is fields at layers 4-7, the user identification is saved in the service detection rule table of the user, and the searched service type and the field information for judging the service type are saved in the service judgment template of the service detection rule table of the user.

At Step 502, it is to receive a message and execute a policy rule and/or a service detection rule for the received message according to the policy rule table and/or the service detection rule table.

In this step, after the policy execution device receives a message, a service type of the received message in a service judgment template of the policy rule table is searched according to field information for judging the service type in the message, a service chain identification is inserted in the received message according to an operation corresponding to the searched service type, and the message obtained after the insertion of the service chain identification is forwarded to a switching device.

When the service type of the received message is not searched in the service judgment template in the policy rule table, the service type of the received data message is searched in the service judgment template in the service detection rule table, the service chain identification is inserted in the received message according to an operation corresponding to the searched service type, and the message is forwarded to the switching module.

When the service type of the received data message is not searched in the service judgment template of the service detection rule table, service chain processing is exited.

Therein, the service types correspond to different service chain identifications, and the service chain identification corresponding to the service type is inserted in the message according to the service type.

In the method provided by the embodiment of the present invention, the method further comprises:

At Step 503, it is to arrange a service logic link table, the service logic link table comprises service chain identifications and corresponding service node arrangement sequences.

In this step, as shown in Table 4, the service logic link table comprises service chain identifications and corresponding service node arrangement sequences.

TABLE 4

| Service chain | |
|---|---|
| identification | Service node arrangement sequence |
| Service chain 1 | Service node 1 -> service node 2 -> service node 3 -> |
| | service node 4 |
| Service chain 2 | Service node 1 -> service node 3 |
| Service chain 3 | Service node 2 -> service node 1 -> service node 3 |
| . . . | |

In table 4, the service node arrangement sequence service node 1−> service node 2−> service node 3−> service node 4 denotes that the message sequentially passes through service nodes 1-4.

The service node arrangement sequence therein further comprises description information of service nodes, e.g., address information of service nodes, and the address information can be address information (such as IP addresses) of hosts (or virtual machines) in which the service nodes are located, or consists of address information (such as IP addresses) of hosts (or virtual machines) in which the service nodes are located and instance identifications.

In this step, the service identification template can be generated. How to specifically generate the service identification template belongs to the prior art and cannot be used for limiting the protection range of the present invention.

At Step 504, it is to generate a service chain routing table according to a network topology and the service logic link table.

In this step, address information of the service chain table node is acquired in the service logic link table; a switching device related to the service chain table node is acquired according to information of the network topology; and a service chain routing table corresponding to the switching device is generated according to the service logic link table and the service chain routing table is issued to the switching device.

In this step, as shown in Table 5, the service chain routing table comprises input ports, service chain identifications and output ports, and can further comprise sequences.

TABLE 5

| | Service chain | | |
|---|---|---|---|
| Input port | identification | Sequence | Output port |
| 1 | Service chain 1 | 1 | 8 |
| 8 | Service chain 1 | 2 | n |
| 1 | Service chain 2 | 1 | 3 |
| 3 | Service chain 2 | 2 | 7 |
| 7 | Service chain 3 | 3 | 9 |
| . . . | . . . | . . . | . . . |

The input ports refer to physical or logical ports, for receiving messages, of switches/routers;

The Service Chain (SC) identifications are used for matching with SC identification fields in the received messages to indicate the output ports for switching/routing of the data messages.

The output ports refer to output physical or logical ports, for forwarding the data messages, of switches/routers.

The sequences refer to arrangement sequences of output ports of a plurality of service nodes when the same SC identification is correspondingly connected with the plurality of service nodes in one switch/router.

At Step 505, it is to forward the message obtained after the execution of the policy rule and/or the service detection rule according to the service chain routing table.

It needs to be stated that the above-mentioned embodiments are just used for facilitating the understanding by one skilled in the art instead of limiting the protection range of the present invention. Any obvious replacement, improvement and the like made by one skilled in the art to the present invention without departing from the invention concept of the present invention shall be also included in the protection range of the present invention.

One skilled in the art should understand that all components of the devices and/or system and all steps in the method provided by the embodiments of the present invention can be implemented by adopting general computing devices, can be integrated on a single computing device, can also be distributed in a network consisting of a plurality of computing devices, optionally can also be implemented program codes executable by computing devices, thus can be stored in storage devices and can be executed by the computing devise, or can be respectively fabricated into integrated circuit modules, or a plurality of modules or steps thereof can be fabricated into a single integrated circuit module for implementation. Therefore, the present invention is not limited to any specific combination of hardware and software.

### INDUSTRIAL APPLICABILITY

Through the solutions provided by the embodiments of the present invention, dynamic configuration of service chains is realized, such that the dynamically configured service chains are applicable to elastic quick service deployment change.

1. A service chain management system, comprising a service arrangement device, a policy control device and a policy execution device, wherein:
the service arrangement device is configured to generate a service chain mapping table and send the service chain mapping table to the policy control device, the service chain mapping table comprises service chain identifications and corresponding service chain condition features;
the policy control device is configured to search for a corresponding service chain identification in the service chain mapping table according to a service chain condition feature of user equipment and generate a policy rule table and/or a service detection rule table of the user equipment, the policy rule table and/or the service detection rule table comprises service chain identification operation information; and
the policy execution device is configured to receive a message and execute a policy rule and/or a service detection rule for the received message according to the policy rule table and/or the service detection rule table.

2. The system according to claim 1, wherein the service arrangement device is further configured to arrange a service logic link table, the service logic link table comprises service chain identifications and corresponding service node arrangement sequences;
the system further comprises a network management device and a switching device;
the policy execution device is further configured to forward the message obtained after the execution of the policy rule and/or service detection rule to the switching device;
the network management device is configured to generate a service chain routing table according to a network topology and the service logic link table; and
the switching device is configured to forward the message obtained after the execution of the policy rule and/or the service detection rule according to the service chain routing table.

3. The system according to claim 2, wherein the policy rule table and/or the service detection rule further comprises a service judgment template, and
wherein the service judgment template comprises service types and field information for judging the service types.

4. (canceled)

5. The system according to according to claims 1-4, wherein the service chain identification operation information is used for instructing the policy execution module to add a service chain identification at a specific position in the message obtained after the execution of the policy rule and/or the service detection rule, the specific position is statically configured by the policy control module or is indicated by the service arrangement module in the service chain mapping table.

6. The system according to claim 4, wherein the service chain condition features comprise service types, user levels, access types and wireless network states; and the policy control device is configured to:
when the user equipment accesses to a network, search for a corresponding service type in the service chain condition features of the service chain mapping table according to a user level, an access type and a wireless network state of the user equipment, search for corresponding field information for judging the service type in the service identification template according to the searched service type, and if judging that the searched field information for judging the service type is one or a combination of a plurality of fields at layers 2-4, save a user identification in the policy rule table of the user, and save the searched service type and the field information for judging the service type in the service judgment template of the policy rule table of the user; and
if judging that the searched field information for judging the service type is fields at layers 4-7, save the user identification in the service detection rule table of the user, and save the searched service type and the field information for judging the service type in the service judgment template of the service detection rule table of the user,
wherein the service identification template is generated by the service arrangement device or is statically configured by the policy control device; and the service identification template comprises the service types and the field information for judging the service types, and
wherein the policy execution device is configured to:
save the policy rule table and the service detection rule table; receive a message, search for a service type of the received message in the service judgment template in the policy rule table according to field information for judging the service type in the message, insert a service chain identification in the received message according to an operation corresponding to the searched service type, and forward the message obtained after the insertion of the service chain identification to the switching device.

7. (canceled)

8. The system according to claim 7, wherein the policy execution device is further configured to:
when the service type of the received message is not searched in the service judgment template in the policy rule table, search for the service type of the received message in the service judgment template in the service detection rule table, insert the service chain identification in the received message according to an operation corresponding to the searched service type, and forward the message to the switching device, or,
the policy execution device is further configured to:
when the service type of the received data message is not searched in the service judgment template of the service detection rule table, exit service chain processing.

9. (canceled)

10. The system according to claim 2, wherein the service nodes consist of addresses of hosts or virtual machines, or addresses and instance identifications of the hosts or the virtual machines. and
wherein the network management device is configured to:
acquire address information of a service chain table node in the service logic link table; acquire a switching device related to the service chain table node according to information of the network topology; and generate a service chain routing table corresponding to the switching device according to the service logic link table and send the service chain routing table to the switching device, and
wherein the service chain routing table comprises input ports, service chain identifications and corresponding output ports.

11. (canceled)

12. (canceled)

13. A service arrangement device, comprising:
a generation module configured to generate a service chain mapping table and send the service chain mapping table to a policy control device, wherein the service chain mapping table comprises service chain identifications and corresponding service chain condition features.

14. The service arrangement device according to claim 13, wherein the generation module is further configured to arrange a service logic link table, wherein the service logic link table comprises service chain identifications and corresponding service node arrangement sequences.

15. A policy control device, comprising:
a search module configured to search for a corresponding service chain identification in a service chain mapping table according to a service chain condition feature of user equipment and generate a policy rule table and/or a service detection rule table of the user equipment, wherein the policy rule table and/or the service detection rule table comprises service chain identification operation information.

16. The policy control device according to claim 15, wherein the service chain condition features comprise service types, user levels, access types and wireless network states; and the search module is configured to:
when the user equipment accesses to a network, search for a corresponding service type in the service chain condition features of the service chain mapping table according to a user level, an access type and a wireless network state of the user equipment, and search for corresponding field information for judging the service type in a service identification template according to the searched service type;
if judging that the searched field information for judging the service type is one or a combination of a plurality of fields at layers 2-4, save a user identification in the policy rule table of the user, and save the searched service type and the field information for judging the service type in the service judgment template of the policy rule table of the user; and if judging that the searched field information for judging the service type is fields at layers 4-7, save the user identification in the service detection rule table of the user, and save the searched service type and the field information for judging the service type in the service judgment template of the service detection rule table of the user.

17. A policy execution device, comprising:
a policy execution module configured to save a policy rule table; receive a message and search for a service type of the received message in a service judgment template of the policy rule table according to field information for judging the service type in the message; and insert a service chain identification in the received message according to an operation corresponding to the searched service type, and forward the message obtained after the insertion of the service chain identification to a switching device; and
a service detection module configured to save a service detection rule table.

18. The policy execution device according to claim 17, wherein the policy execution module is further configured to, when the service type of the received message is not searched in the service judgment template in the policy rule table, forward the received message to the service detection module; and
the service detection module is further configured to receive the message from the policy execution module; search for the service type of the received message in the service judgment template of the service detection rule table; and insert a service chain identification in the received message according to an operation corresponding to the searched service type, and forward the message obtained after the insertion of the service chain identification to the switching device.

19. A network management device, comprising:
an acquisition module configured to acquire address information of a service chain table node in a service logic link table; and acquire a switching device related to the service chain table node according to information of a network topology; and
a generation module configured to generate a service chain routing table corresponding to the switching device according to the service logic link table and send the service chain routing table to the switching device.

20. The network management device according to claim 19, wherein the service chain routing table comprises input ports, service chain identifications and corresponding output ports.

21. A service chain management method, comprising:
generating a service chain mapping table;
searching for a corresponding service chain identification in the service chain mapping table according to a service chain condition feature of user equipment and generating a policy rule table and/or a service detection rule table of the user equipment, wherein the policy rule table and/or the service detection rule table comprises service chain identification operation information; and
receiving a message and executing a policy rule and/or a service detection rule for the received message according to the policy rule table and/or the service detection rule table.

22. The method according to claim 21, wherein the method further comprises:
arranging a service logic link table, wherein the service logic link table comprises service chain identifications and corresponding service node arrangement sequences;
generating a service chain routing table according to a network topology and the service logic link table; and
forwarding the message obtained after the execution of the policy rule and/or the service detection rule according to the service chain routing table.

23. The method according to claim 22, wherein the policy rule table and/or the service detection rule further comprises a service judgment template, and
wherein the service judgment template comprises service types and field information for judging the service types.

24. (canceled)

25. The method according to claims 21, wherein the service chain identification operation information is used for instructing to add a service chain identification at a specific position in the message obtained after the execution of the policy rule and/or the service detection rule, the specific position is statically configured or is indicated in the service chain mapping table.

26. The method according to claim 24, wherein said searching for a corresponding service chain identification in the service chain mapping table according to a service chain condition feature of user equipment and generating a policy rule table and/or a service detection rule table of the user equipment comprises:
when the user equipment accesses to a network, searching for a corresponding service type in the service chain condition features of the service chain mapping table according to a user level, an access type and a wireless network state of the user equipment, searching for corresponding field information for judging the service type in the service identification template according to the searched service type, and if judging that the searched field information for judging the service type is one or a combination of a plurality of fields at layers 2-4, saving a user identification in the policy rule table of the user, and saving the searched service type and the field information for judging the service type in the service judgment template of the policy rule table of the user; and
if judging that the searched field information for judging the service type is fields at layers 4-7, saving the user identification in the service detection rule table of the user, and saving the searched service type and the field information for judging the service type in the service judgment template of the service detection rule table of the user,
wherein the service identification template is generated in advance or is statically configured; and the service identification template comprises the service types and the field information for judging the service types, and
wherein said receiving a message and executing a policy rule and/or a service detection rule for the received message according to the policy rule table and/or the service detection rule table comprises:
receiving a message, searching for a service type of the received message in the service judgment template in the policy rule table according to field information for judging the service type in the message, inserting a service chain identification in the received message according to an operation corresponding to the searched service type, and forwarding the message obtained after the insertion of the service chain identification to a switching device.

27. (canceled)

28. The method according to claim 27, wherein, when the service type of the received message is not searched in the service judgment template in the policy rule table, the method further comprises:
searching for the service type of the received message in the service judgment template in the service detection rule table, inserting the service chain identification in the received message according to an operation corresponding to the searched service type, and forwarding the message to the switching module, or,
wherein, when the service type of the received data message is not searched in the service judgment template of the service detection rule table, the method further comprises:
exiting service chain processing.

29. (canceled)

30. The method according to claim 22, wherein the service logic link table comprises service chain identifications and service node arrangement sequences corresponding to the service chain identifications; and
the service nodes consist of addresses of hosts or virtual machines, or addresses and instance identifications of the hosts or the virtual machines, and
wherein said generating a service chain routing table according to a network topology and the service logic link table comprises:
acquiring address information of a service chain table node in the service logic link table; acquiring a switching device related to the service chain table node according to information of the network topology; and generating a service chain routing table corresponding to the switching device according to the service logic link table and sending the service chain routing table to the switching device, and
wherein the service chain routing table comprises input ports, service chain identifications and corresponding output ports.

31. (canceled)

32. (canceled)
